(19) United States
(12) Patent Application Publication
(10) Pub. No.: US 2005/0256219 A1
(43) Pub. Date: Nov. 17, 2005

(54) Photocurable resin composition and optical component

(76) Inventors: Hideaki Takase, Tokyo (JP); Atsuya Takahashi, Tokyo (JP); Takayoshi Tanabe, Tokyo (JP); Shingo Itai, Tokyo (JP); Satoshi Futami, Tokyo (JP)

Correspondence Address: MAYER, BROWN, ROWE & MAW LLP, 1909 K STREET, N.W., WASHINGTON, DC, 20006, US

(21) Appl. No.: 10/507,482

(22) PCT Filed: Mar. 6, 2003
(86) PCT No.: PCT/IL03/00184

§ 371 Date: May 9, 2005

(30) Foreign Application Priority Data
Mar. 11, 2002 (JP) 02/65451
May 31, 2002 (JP) 02159899

(51) Int. Cl. C08G 2/00

(52) U.S. Cl. 522/7

(57) ABSTRACT

The invention relates to a photocurable resin composition comprising: (A) (A1) a (meth)acrylate having a structure shown by the formula (1) or (2), or (A2) an epoxy compound having a structure shown by the formula (1) or (2); (B) a (meth)acrylate having three or more functional groups other than (A1); (C) a radical photoinitiator; (D) a compound having three or more cyclic ether linkages in the molecule other than (A2) and (E) a cationic photoinitiator; the invention also relates to optical parts made from the resins of the invention and use of the resin in other applications.

### FIELD OF THE INVENTION

The present invention relates to a photocurable resin composition. For example, the present invention relates to a photocurable resin composition useful for forming an optical component such as a lens of a prism lens sheet used for a backlight of a liquid crystal display and a Fresnel lens sheet or a lenticular lens sheet used for a screen of a projection TV or a backlight using such sheets. The photocurable resin compositions of the present invention may also be used for other applications, like for example stereolithography, coatings for various substrates and adhesives for for example DVD.

### PRIOR ART

Conventionally, lenses such as a Fresnel lens and a lenticular lens are manufactured using a press-forming process or a casting process. However, these processes require a long period of time for manufacturing the lens, thereby resulting in poor productivity. In order to solve this problem, a method of manufacturing a lens using a UV-curable resin has been studied in recent years. An example of such a method is the following: a UV-curable resin composition is poured between a mold having a lens shape and a transparent resin substrate, and the composition is cured by irradiation using ultraviolet rays from the side of the substrate, whereby a lens can be manufactured in a short period of time.

In order to solve problems during production relating to adhesion to substrates, like for example releasability of the lens from the mold, Japanese Patent Application Laid-open No. 8-259649 proposes a resin composition for forming a lens comprising an ethylenically unsaturated group containing compound, a radical photoinitiator, a cationically polymerizable compound, and a cationic photoinitiator.

### PROBLEMS TO BE SOLVED BY THE INVENTION

In the case of using a hard lens sheet, the sheet may be warped during the production or the lens shape may be deformed when the lens sheet is used at a high temperature of about 60° C. and thereafter cooled to room temperature depending on the use conditions. As a result, distortion may occur in the resulting image.

Accordingly, an object of the present invention is to provide a photocurable resin composition capable of producing a cured product excelling in heat resistance, showing only a small amount of deformation. Preferably, the cured product is useful as an optical component.

### MEANS FOR SOLVING THE PROBLEMS

The present inventors have conducted extensive studies and found photocurable resin compositions that produce cured products excelling in heat resistance, showing only a small amount of deformation.

A first embodiment of the present invention is a photocurable resin composition comprising a (meth)acrylate comprising a specific structure (FIG. 1 or FIG. 2), and/or an epoxy compound comprising a similar specific structure, a radical photoinitiator, and a cationic photoinitiator.

A second embodiment of the present invention is a photocurable composition comprising at least two types of (meth)acrylates having specific structures (as shown in FIGS. 1 and 2) and a radical photoinitiator, wherein 5-50 wt % of the total acrylic components in the composition is a methacrylate component.

### PREFERRED EMBODIMENTS OF THE INVENTION

Preferably, the present invention provides a photocurable resin composition comprising (A) (A1) a (meth)acrylate having a structure shown by the following formula (1) or (2), or (A2) an epoxy compound having a structure shown by the formula (1) or (2), (B) a (meth)acrylate having three or more functional groups other than (A1), (C) a radical photoinitiator, (D) optionally a compound having three or more cyclic ether linkages in the molecule other than (A2), and (E) a suitable cationic photoinitiator. Preferably the composition contains 5-50% methacrylate compounds when (A2) and/or (D) and E are absent. The invention also provides articles made from the resin compositions of the invention.

Component (A) comprises a structure as represented in formula (1) or (2): 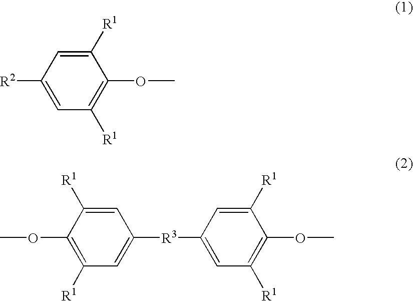
wherein R¹ represents a hydrogen atom or a halogen atom, excluding a fluorine atom, R² represents a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—,

As examples of the halogen atom shown by R¹ other than a fluorine atom in the formulas (1) to (2), chlorine atom, bromine atom, and iodine atom can be given. Of these, a bromine atom is preferable.

Preferably as the (meth)acrylate having the structure shown by the formula (1) component (A1) may be the compound shown by the following formula (3): 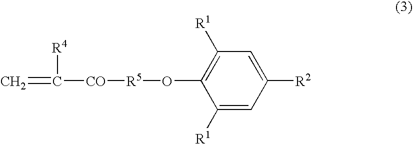
wherein R⁴ represents a hydrogen atom or a methyl group, R⁵ represents —C(OCH₂CH₂)ₖ, —(OCH₂CH(CH₃))ₗ—, or —OCH₂CH(OH)CH₂—, k and l are individually an integer from 0 to 10, and R¹ and R² are the same as defined above.

As the (meth)acrylate having the structure shown by the formula (2), a compound shown by the following formula (4) is preferable: 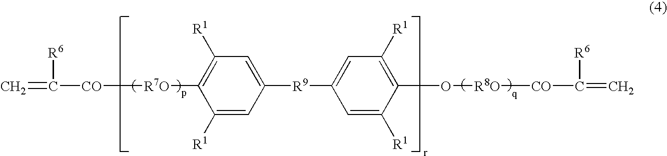
wherein R⁶ represents a hydrogen atom or a methyl group, R⁷ and R⁸ represent —CH₂CH₂—, —CH₂CH(CH₃)—, or —CH₂CH(OH)CH₂—, R⁹ represents —CH₂—, —S—, or —C(CH₃)₂)—, p, q, and r are individually an integer from 0 to 10, and R¹ is the same as defined above.

Examples of the (meth)acrylate (A1) having the structure shown by the formula (1) are phenoxyethyl (meth)acrylate, phenoxy-2-methylethyl(meth)acrylate, phenoxyethoxyethyl(meth)acrylate, 3-phenoxy-2-hydroxypropyl(meth)acrylate, 2-phenylphenoxyethyl(meth)acrylate, 4-phenylphenoxyethyl(meth)acrylate, 3-(2-phenylphenyl)-2-hydroxypropyl(meth)acrylate, (meth)acrylate of p-cumylphenol which is reacted with ethylene oxide, 2-bromophenoxyethyl(meth)acrylate, 2,4-dibromophenoxyethyl(meth)acrylate, and 2,4,6-tribromophenoxyethyl(meth)acrylate. Of these, phenoxyethyl(meth)acrylate, phenoxyethoxyethyl(meth)acrylate, (meth)acrylate of p-cumylphenol reacted with ethylene oxide and 2,4,6-tribromophenoxyethyl(meth)acrylate are particularly preferable.

Examples of the (meth)acrylate (A1) having the structure shown by the formula (2) are ethylene oxide addition (tetrabromo)bisphenol A(meth)acrylate, propylene oxide addition (tetrabromo)bisphenol A(meth)acrylate, (tetrabromo)bisphenol A diglycidyl ether epoxy(meth)acrylate obtained by epoxy ring-opening reaction of (tetrabromo)bisphenol A diglycidyl ether and (meth)acrylic acid and (tetrabromo)bisphenol F diglycidyl ether epoxy(meth)acrylate obtained by epoxy ring-opening reaction of (tetrabromo)bisphenol F diglycidyl ether and (meth)acrylic acid. Of these, ethylene oxide addition (tetrabromo)bisphenol A(meth)acrylate, (tetrabromo)bisphenol A diglycidyl ether epoxy(meth)acrylate obtained by epoxy ring-opening reaction of (tetrabromo)bisphenol A diglycidyl ether and (meth)acrylic acid are particularly preferable. (Tetrabromo)bisphenol represents bisphenol or tetrabromobisphenol. (Meth)acrylate represents acrylate or methacrylate.

Examples of commercially available products having the structure shown by the formula (1) are Aronix M113, M110, M101, M102, M5700, TO-1317 (manufactured by Toagosei Co., Ltd.), Viscoat #192, #193, #220, 3BM (manufactured by Osaka Organic Chemical Industry Co., Ltd.), NK Ester AMP-10G, AMP-20G (manufactured by Shin-Nakamura Chemical Co., Ltd.), Light Acrylate PO-A, P-200A, Epoxy Ester M600A (manufactured by Kyoeisha Chemical Co., Ltd.), PHE, CEA, PHE-2, BR-30, BR-31, BR-31M, BR-32 (manufactured by Daiichi Kogyo Seiyaku Co., Ltd.).

Examples of commercially available products the (meth)acrylate having the structure shown by the formula (2) are Viscoat #700, #540 (manufactured by Osaka Organic Chemical Industry Co., Ltd.), Aronix M-208, M210 (manufactured by Toagosei Co., Ltd.), NK Ester BPE-100, BPE-200, BPE-500, A-BPE-4 (manufactured by Shin-Nakamura Chemical Co., Ltd.), Light Ester BP4EA, BP4PA, Epoxy Ester 3002M, 3002A, 3000M ,3000A (manufactured by Kyoeisha Chemical Co., Ltd.), Kayarad R-551, R-712 (manufactured by Nippon Kayaku Co., Ltd.), BPE-4, BPE-10, BR-42M (manufactured by baiichi Kogyo Seiyaku Co., Ltd.), Lipoxi VR-77, VR-60, VR-90, SP-1506, SP-1507, SP-1509, SP-1563 (manufactured by Showa Highpolymer Co., Ltd.), Neopole V779 and Neopole V779MA (manufactured by Japan U-PiCA Co., Ltd.).

Examples of the epoxy compound (A2) are epoxy compounds having at least one epoxy group in the molecule such as phenyl glycidyl ether and bisphenol-type epoxy resin such as compounds obtained by reacting a bisphenol such as bisphenol A, bisphenol F, bisphenol S, and tetrabisphenol A with epichlorohydrin and/or methylepichlorohydrin and compounds obtained by reacting bisphenol A diglycidyl ether or bisphenol F diglycidyl ether with a condensate of the above bisphenol and epichlorohydrin; a novolac epoxy resin such as compounds obtained by reacting a phenol such as phenol, cresol, halogenation phenol, and alkylphenol with formaldehyde in the presence of an acid catalyst with epichlorohydrin.

Examples of commercially available products of these epoxy compounds are Epolight 3002 (manufactured by Kyoeisha Chemical Co., Ltd.), Placcel GL61, G101, G401 (manufactured by Daicel Chemical Industries, Ltd.), Epikote 828, 807, 5050, 5051, 5054 (manufactured by Japan Epoxy Resins Co., Ltd.).

The component (A1) and the component (A2) may be used either individually or in combination of two or more.

The content of the component (A) in the composition is preferably 20-80 wt %, and particularly preferably 30-70 wt %. The lower limit of the content is preferable in view of the refractive index. The upper limit of the content is preferable in view of viscosity and heat resistance of the cured product.

In case epoxy component (A2) or (D) is not present, or a suitable cationic photoinitiator is absent, the amount of methacrylate compounds is preferably between 5-50 wt % of the total acrylic components in the composition. A methacrylate compound is a compound having at least one methacrylate group.

The component (B) is a (meth)acrylate compound having three or more functional groups. The component (B) differs from (A1). Examples of component (B) are (meth)acrylates of an alcohol having three or more hydroxyl groups such as trimethylolpropane tri(meth)acrylate, pentaerythritol tri(meth)acrylate, trimethylolpropane trioxyethyl(meth)acrylate, and tris(2-acryloyloxyethyl)isocyanurate. These compounds may be used either individually or in combination of two or more.

Examples of commercially available products of these compounds are Aronix M305, M309, M310, M315, M320, M350, M360, M408 (manufactured by Toagosei Co., Ltd.), Viscoat #295, #300, #360, GPT, 3PA, #400 (manufactured by Osaka Organic Chemical Industry Co., Ltd.), NK Ester TMPT, A-TMPT, A-TMM-3, A-TMM-3L, A-TMMT (manufactured by Shin-Nakamura Chemical Co., Ltd.), Light Acrylate TMP-A, TMP-6EO-3A, PE-3A, PE-4A, DPE-6A (manufactured by Kyoeisha Chemical Co., Ltd.), Kayarad PET-30, GPO-303, TMPTA, TPA-320, DPHA, D-310, DPCA-20 and DPCA-60 (manufactured by Nippon Kayaku Co., Ltd.).

The content of the component (B) in the composition is preferably 5-40 wt %, and particularly preferably 10-30 wt %. The lower limit of the content is preferable in view of heat resistance of the cured product. The upper limit of the content is preferable in view of preventing a decrease in the refractive index.

The component (C) is a radical photoinitiator. Examples of the radical photoinitiator are acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6trimethylbenzoyl diphenylphosphine oxide and bis-(2,6-dimethoxybenzoyl)-2,4,4-trimethylpentylphosphine oxide.

Examples of commercially available products of the radical photoinitiator are Irgacure 184, 369, 651, 500, 819, 907, 784, 2959, CGI1700, CGI1750, CGI11850, CG24-61, Darocur 116, 1173 (manufactured by Ciba Specialty Chemicals Co., Ltd.), Lucirin LR8728 (manufactured by BASF) and Ubecryl P36 (manufactured by UCB).

The content of the component (C) in the composition is preferably 0.01-10 wt %, and particularly preferably 0.5-7 wt %. The upper limit is preferable in view of ensuring cure characteristics of the composition, mechanical characteristics and optical characteristics of the cured product, handling capability, and the like. The lower limit is preferable for preventing a decrease in the cure speed.

The compositions of the present invention may contain a component (D), being a compound having three or more cyclic ethers in the molecule differing from (A2). Examples of optional component (D) are alicyclic epoxy compounds having three or more alicyclic epoxy groups in the molecule such as an oxirane compound, an oxetane compound, and an oxolane compound. Examples of the oxirane compound are an epoxy novolac resin, glycerol triglycidyl ether, trimethylolpropane triglycidyl ether, pentaerythritol tetraglycidyl ether, pentaerythritol triglycidyl ether, diglycerol tetraglycidyl ether, diglycerol triglycidyl ether, sorbitol hexaglycidyl ether, sorbitol pentaglycidyl ether, sorbitol tetraglycidyl ether, sorbitol triglycidyl ether; polyglycidyl ether and polycyclohexene oxide obtained by adding one or more alkylene oxides and caprolactones to an aliphatic polyhydric alcohol such as glycerol and sorbitol. As examples of the oxetane compound, trimethylolpropane tris(3-ethyl-3-oxetanylmethyl)ether, pentaerythritol tris(3-ethyl-3-oxetanylmethyl)ether, pentaerythritol tetrakis(3-ethyl-3-oxetanylmethyl)ether, and the like can be given. These compounds may be used either individually or in combination of two or more.

As commercially available products of these compounds, Epolite 40E, 100 E, 70P, 1500NP, 100MF, 4000, 3002 (manufactured by Kyoeisha Chemical Co., Ltd.), Epolead GT301, GT302, GT401, GT402, EHPE, PB3600, Epofriend A1005, A1010, A1020 (manufactured by Daicel Chemical Industries, Ltd.), Denacol EX-611, 612, 512, 521, 411, 421, 313, 314, 321 (manufactured by Nagase Kasei Co., Ltd.), PA36-PEP (manufactured by Yokkaichi Gosei Co., Ltd.), and the like can be given.

The content of the component (D) in the composition is preferably 5-40 wt %, and particularly preferably 10-30 wt %. The lower limit of the content is preferable in view of deformation of the cured product. The upper limit of the content is preferable in view of preventing a decrease in the refractive index.

In case component (A2) and/or component (D) are present, a cationic phoitoinitiator (E) will also be present. Any cationic photoinitiator that has catalytic activity in the resin composition of the present invention may be suitably used. Preferably the component (E) is a cationic photoinitiator containing a phosphorus atom. An example of the component (E) is an onium salt having a structure shown by the following formula (7). The onium salt generates a Lewis acid upon exposure to light.
[R¹⁵ₐR¹⁶_{b}R¹⁷_{c}R¹⁸_{d}W]+m[MXₙ₊ₘ]^{-m} (7)
wherein a cation is an onium ion; W is S, Se, Te, P, As, Sb, Bi, O, I, Br, Cl, or N≡N; R¹⁵, R¹⁶, R¹⁷, and R¹⁸ are the same or different organic groups; a, b, c, and d are integers from 0 to 3, provided that (a+b+c+d) is equal to the valence of W. M makes up the center atom of the halide complex [MXₙ₊ₘ]. Preferably a phosphorus atom is used as M, X is a halogen atom such as F, Cl, or Br; m is a net charge of a halide complex ion; and n is the valence of M.

Specific examples of the onium ion in the formula (7) are diphenyliodonium, 4-methoxydiphenyliodonium, bis(4-methylphenyl)iodonium, bis(4-tert-butylphenyl)iodonium, bis(dodecylphenyl)iodonium, triphenylsulfonium, diphenyl-4-thio-phenoxyphenylsulfonium, bis[4-(diphenylsulfonio)-phenyl]sulfide, bis[4-(di(4-(2-hydroxyethyl)phenyl)sulfonio)-phenyl]sulfide, and η⁵-[2,4-(cyclopentadienyl)(1,2,3,4,5,6-η)-(methylethyl)-benzene]-iron(1+).

As specific examples of the anion [MXₙ₊ₘ] in the formula (7), hexafluorophosphate (PF₆⁻) and the like can be given.

As commercially available products of the cationic photoinitiator, UVI-6990 (manufactured by Union Carbide), Adekaoptomer SP-150, SP-152 (manufactured by Asahi Denka Kogyo Co., Ltd.), Sanaide SI-110, 180 (manufactured by Sanshin Chemical Industry Co., Ltd.), and the like can be given.

The content of the component (E) in the composition is preferably 0.01-10 wt %, and particularly preferably 0.5-7 wt %. The upper limit is preferable in view of ensuring cure characteristics of the composition, mechanical characteristics and optical characteristics of the cured product, and storage stability of the composition. The lower limit is preferable for preventing a decrease in the cure speed.

The composition of the present invention may further comprise a photosensitizer. Examples of the photosensitizer are triethylamine, diethylamine, N-methyldiethanoleamine, ethanolamine, 4-dimethylaminobenzoic acid, methyl 4-dimethylaminobenzoate, ethyl 4-dimethylaminobenzoate and isoamyl 4-dimethylaminobenzoate. Commercially available products of the photosensitizer are for example Ubecryl P102, 103, 104, and 105 (manufactured by UCB).

In the present invention, a compound having a (meth)acryloyl group or a vinyl group other than the components (A) to (E) may be added as an optional component (hereinafter referred to as “unsaturated monomer”). As the unsaturated monomer, vinyl monomers such as for example N-vinylpyrrolidone, N-vinylcaprolactam, vinylimidazole, and vinylpyridine, isobomyl(meth)acrylate, bomyl(meth)acrylate, tricyclodecanyl(meth)acrylate, dicyclopentanyl(meth)acrylate, dicyclopentenyl(meth)acrylate, cyclohexyl(meth)acrylate, benzyl(meth)acrylate, 4-butylcyclohexyl(meth)acrylate, acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypolypropylene glycol(meth)acrylate, diacetone(meth)acrylamide, isobutoxymethyl(meth)acrylamide, N,N-dimethyl(meth)acrylamide, t-octyl(meth)acrylamide, dimethylaminoethyl(meth)acrylate, diethylaminoethyl (meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and monofunctional monomers shown by following formulas (5) and (6) can be given: 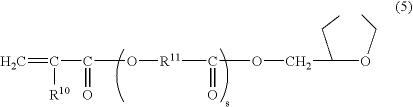
wherein R¹⁰ represents a hydrogen atom or a methyl group, R¹¹ represents an alkylene group having 2-8 carbon atoms, and s is an integer from 0 to 8; 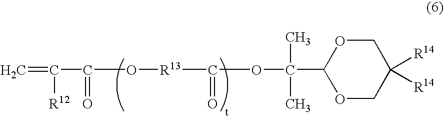
wherein R¹² and R¹⁴ individually represent a hydrogen atom or a methyl group, R¹³ represents an alkylene group having 2-8 carbon atoms, and t is an integer from 1 to 8.

Further examples include unsaturated monomers having two (meth)acryloyl groups or two vinyl groups in the molecules such as an alkyldiol diacrylate such as 1,4-butanediol diacrylate, 1,6-hexanediol diacrylate, and 1,9-nonanediol diacrylate, polyalkylene glycol diacrylate such as tetraethylene glycol diacrylate and tripropylene glycol diacrylate, tricyclodecanemethanol diacrylate.

The composition of the present invention may further include a urethane(meth)acrylate oligomer. As examples of the urethane(meth)acrylate, urethane(meth)acrylate oligomers prepared from a polyether polyol such as polyethylene glycol and polytetramethyl glycol, polyester polyol obtained by the reaction of a dibasic acid such as succinic acid, adipic acid, azelaic acid, sebacic acid, phthalic acid, tetrahydrophthalic acid(anhydride), hexahydrophthalic acid(anhydride) with a diol such as ethylene glycol, propylene glycol, diethylene glycol, triethylene glycol, tetraethylene glycol, dipropylene glycol, 1,4-butanediol, 1,6-hexanediol, and neopentyl glycol, poly □-caprolactone-modified polyol, polymethylvalerolactone-modified polyol, ethylene glycol, propylene glycol, 1,4-butanediol, and 1,6-hexanediol, alkyl polyol such as neopentyl glycol, bisphenol A skeleton alkylene oxide modified polyol such as ethylene oxide addition bisphenol A and propylene oxide addition bisphenol A, bisphenol F skeleton alkylene oxide modified polyol such as ethylene oxide addition bisphenol F and propylene oxide addition bisphenol F, or a mixture of these, an organic polyisocyanate such as tolylene diisocyanate, isophorone diisocyanate, hexamethylene diisocyanate, diphenylmethane diisocyanate, and xylylene diisocyanate, and a hydroxyl group-containing (meth)acrylate such as 2-hydroxyethyl(meth)acrylate and 2-hydroxypropyl(meth)acrylate; and the like can be given. Use of the urethane(meth)acrylate oligomer is preferable in order to maintain the viscosity of the curable composition of the present invention at a moderate level. The urethane(meth)acrylate oligomer is used in the composition of the present invention in an amount of preferably 4.99-40 wt %, and still more preferably 4.99-20 wt %.

As examples of commercially available products of the urethane (meth)acrylate oligomer, Aronix M 120, M-150, M-156, M-215, M-220, M-225, M-240, M-245, M-270 (manufactured by Toagosei Co., Ltd.), AIB, TBA, LA, LTA, STA, Viscoat #155, IBXA, #158, #190, #150, #320, HEA, HPA, #2000, #2100, DMA, #195, #230, #260, #215, #335HP, #310HP, #310HG, #312 (manufactured by Osaka Organic Chemical Industry Co., Ltd.), Light Acrylate IAA, L-A, S-A, BO-A, EC-A, MTG-A, DMP-A, THF-A, IB-XA, HOA, HOP-A, HOA-MPL, HOA-MPE, 3EG-A, 4EG-A, 9EG-A, NP-A, 1,6HX-A, DCP-A (manufactured by Kyoeisha Chemical Co., Ltd.), Kayarad TC-110S, HDDA, NPGDA, TPGDA, PEG400DA, MANDA, HX-220, HX-620 (manufactured by Nippon Kayaku Co., Ltd.), FA-511A, 512A, 513A (manufactured by Hitachi Chemical Co., Ltd.), VP (manufactured by BASF), ACMO, DMAA, DMAPAA (manufactured by Kohjin Co., Ltd.), and the like can be given.

Examples of commercially available products of these monomers are Aronix M 120, M-150, M-156, M-215, M-220, M-225, M-240, M-245, M-270 (manufactured by Toagosei Co., Ltd.), AIB, TBA, LA, LTA, STA, Viscoat #155, IBXA, #158, #190, #150, #320, HEA, HPA, #2000, #2100, DMA, #195, #230, #260, #215, #335HP, #310HP, #310HG, #312 (manufactured by Osaka Organic Chemical Industry Co., Ltd.), Light Acrylate IAA, L-A, S-A, BO-A, EC-A, MTG-A, DMP-A, THF-A, IB-XA, HOA, HOP-A, HOA-MPL, HOA-MPE, 3EG-A, 4EG-A, 9EG-A, NP-A, 1,6HX-A, DCP-A (manufactured by Kyoeisha Chemical Co., Ltd.), Kayarad TC-110S, HDDA, NPGDA, TPGDA, PEG400DA, MANDA, HX-220, HX-620 (manufactured by Nippon Kayaku Co., Ltd.), FA-511A, 512A, 513A (manufactured by Hitachi Chemical.Co., Ltd.), VP (manufactured by BASF), ACMO, DMAA, DMAPAA (manufactured by Kohjin Co., Ltd.).

The composition of the present invention may further include the urethane(meth)acrylate oligomer. The urethane(meth)acrylate oligomer is obtained as a reaction product of (a) a hydroxyl group-containing (meth)acrylate, (b) an organic polyisocyanate, and (c) a diol. The urethane(meth)acrylate oligomer is preferably a reaction product obtained by reacting the hydroxyl group-containing (meth)acrylate (a) with the organic polyisocyanate (b), and reacting the resulting product with the diol (c).

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, solvents, fillers, aging preventives, and wettability improvers may optionally be added. Examples of antioxidants are Irganox 1010, 1035, 1076, 1222 (manufactured by Ciba Specialty Chemicals Co., Ltd.), Antigene P, 3C, FR and GA-80 (manufactured by Sumitomo Chemical Industries Co., Ltd.). Examples of UV absorbers are Tinuvin P, 234, 320, 326, 327, 328, 329, 213 (manufactured by Ciba Specialty Chemicals Co., Ltd.), Seesorb 102, 103, 110, 501, 202, 712 and 704 (manufactured by Sypro Chemical Co., Ltd.). Examples of light stabilizers are Tinuvin 292, 144, 622LD (manufactured by Ciba Specialty Chemicals Co., Ltd.), Sanol LS770 (manufactured by Sankyo Co., Ltd.) and Sumisorb TM-061 (manufactured by Sumitomo Chemical Industries Co., Ltd.). Examples of silane coupling agents are γ-aminopropyltriethoxysilane, γ-mercaptopropyltrimethoxysilane, and γ-methacryloxypropyltrimethoxysilane, and commercially available products such as SH6062, SH6030 (manufactured by Toray-Dow Corning Silicone Co., Ltd.), and KBE903, KBE603, KBE403 (manufactured by Shin-Etsu Chemical Co., Ltd.). Examples of coating surface improvers are silicone additives such as dimethylsiloxane polyether and commercially available products such as DC-57, DC-190 (manufactured by Dow-Corning), SH-28PA, SH-29PA, SH-30PA, SH-190 (manufactured by Toray-Dow Corning Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.).

The resin composition of the present invention can be produced by mixing the above components by using a conventional method. Viscosity of the resin composition of the present invention thus prepared is usually from 200 to 50,000 cp/25° C., and preferably from 500 to 30,000 cp/25° C. If the viscosity of the composition is too great, uneven coating or a crinkle may occur or a desired lens thickness may not be obtained when forming a lens, whereby performance of the lens may be insufficient. If the viscosity is too low, it is difficult to control the lens thickness, whereby a lens with a uniform thickness may not be formed. For applications other than making lenses, the viscosity of the resin composition of the present invention may be different than the above values, depending on the specific application.

For applications like lenses, it is particularly preferable that a cured product obtained by curing the resin composition of the present invention by radiation have the following properties. The refractive index of the cured product at 25° C. is preferably 1.55 or more, and still more preferably 1.56 or more. If the refractive index is less than 1.55, sufficient frontal brightness may not be secured when forming a prism lens sheet using the resin composition of the present invention.

The softening point of the cured product is preferably 40° C. or more, and particularly preferably 50° C. or more. If the softening point of the cured product is less than 40° C., heat resistance may be insufficient.

### EXAMPLES

The present invention is described below in more detail by examples, which should not be construed as limiting the scope of the present invention.

### Examples 1-4 and Comparative Examples 1-5

A reaction vessel was charged with components shown in Table 1. The mixture was stirred at 50-60° C. for one hour to obtain a curable liquid resin composition with a viscosity of 500-10000 cps/25° C. The unit for the amount of each component shown in Table 1 is “part by weight”.

The urethane(meth)acrylate in Table 1 was synthesized by the following method. A reaction vessel equipped with a stirrer was charged with 35.47 wt % of 2,4-tolylene diisocyanate, 0.08 wt % of di-n-butyltin dilaurate, and 0.02 wt % of 2,6-di-t-butyl-p-cresol. 23.65 wt % of 2-hydroxyethyl acrylate was added dropwise at 30° C. or less while stirring. After the addition, the mixture was allowed to react at 30° C. for one hour. After the addition of 40.77 wt % of bisphenol A ethylene oxide addition diol (number of ethylene oxide structural units=4; average molecular weight=400), the mixture was allowed to react at 50-70° C. for two hours. The reaction was terminated when the residual isocyanate was 0.1 wt % or less.

Evaluation Method

1. Measurement of Heat Resistance

The curable liquid resin composition was applied to a polyethyleneterephthalate (PET) film with a thickness of 125 μm to a thickness of 70 μm by using an applicator bar. The composition was irradiated with ultraviolet rays at a dose of 1.0 J/cm² in nitrogen atmosphere to obtain a cured film. The sample was cut into a square of 1 cm×1 cm. A column-shaped quartz stick with a diameter of 5 mm was pressed against the test specimen at a load of 20 gf by using a thermal mechanical analysis (TMA) system (manufactured by Seiko Instruments Inc.) while changing the temperature to measure the amount of displacement of the thickness of the test specimen. The temperature increase rate was 5° C./min. The amount of displacement is increased as the temperature is increased. The inflection point at which the amount of displacement was decreased was measured as the softening point. If the inflection point is less than 40° C., when forming a lens sheet using the curable resin composition of the present invention, the shape of the lens may be deformed at high temperature. Therefore, a case where the inflection point was less than 40° C. was judged as “Bad”, and a case where the inflection point was 40° C. or more was judged as “Good”.

The measurement was performed after heating the cured film at 60° C. for three days immediately after irradiation of ultraviolet rays.

2. Measurement of Warping

The curable liquid resin composition was applied to a PET film with a thickness of 125 μm to a thickness of 40 μm by using an applicator bar. The composition was irradiated with ultraviolet rays at a dose of 1.0 J/cm² in nitrogen atmosphere to obtain a cured film. The sample was cut into a square of 8 cm×8 cm and placed on a flat desk with the cured film on the upper side. The height at the four corners of the sample from the desk was measured. The average value of the height was defined as the amount of warping. If the amount of warping exceeds 20 mm, when forming a lens sheet using the curable resin composition of the present invention, optical characteristics such as brightness may be impaired due to curling of the lens. Therefore, a case where the amount of warping exceeded 20 mm was judged as “Bad”, and a case where the amount of warping was 20 mm or less was judged as “Good”. For examples 5-8, a case where the amount of warping was 10 mm or less was judged as “very good”.

The measurement was performed after heating the cured film at 60° C. for three days immediately after irradiation of ultraviolet rays, and heating the cured film at 85° C. for 30 minutes.

The results are shown in Table 1.

TABLE 1

| | | Example | | | | | | | | Comparative example | | | | |
|---|---|---|---|---|---|---|---|---|---|---|---|---|---|---|
| | | 1 | 2 | 3 | 4 | 5 | 6 | 7 | 8 | 1 | 2 | 3 | 4 | 5 |
| (A) | Neopole V779 | 30 | 30 | — | 28 | 31 | — | 16 | — | 28 | 28 | 28 | 28 | — |
| | Neopole V779MA | — | — | — | — | — | 35 | 15 | 35 | — | — | — | — | — |
| | Aronix M110 | 10 | — | 10 | 10 | — | — | — | — | 10 | 10 | 10 | 10 | — |
| | Epikote 5050 | — | — | 28 | — | — | — | — | — | — | — | — | — | — |
| | Ligth Ester PO | — | — | — | — | 15.5 | — | 5.5 | — | — | — | — | — | — |
| | New Frontier PHE | 23 | — | — | — | — | 15.5 | 10 | 15.5 | — | 6 | — | — | — |
| | New Frontier BR31 | — | 30 | 25 | 25 | 17 | 13 | 17 | 13 | 25 | 25 | 25 | 25 | — |
| | Lipoxi VT-77 | — | — | — | — | 10 | 10 | 10 | — | — | — | — | — | — |
| (B) | Aronix M315 | 11 | 9 | 11 | 11 | 5.5 | 5.5 | 5.5 | 5.5 | 21 | — | 11 | 11 | — |
| | DPHA | 6 | 6 | 6 | 6 | — | — | — | — | 16 | — | 6 | 6 | — |
| | Viscoat 295 | — | — | — | — | — | — | — | — | — | — | — | — | 14 |
| (C) | Irgacure 184 | — | — | 3 | 3 | 3 | 3 | 3 | 3 | 3 | 3 | 3 | 3 | 1 |
| | Irgacure 651 | 3 | 3 | — | — | — | | | | — | — | — | — | — |
| (D) | PA36-PEP | — | 25 | — | 20 | — | — | — | — | — | — | 20 | — | — |
| | Denacol EX-411 | — | — | 20 | — | — | — | — | — | — | 31 | — | — | — |
| | Epolead GT401 | 20 | — | — | — | — | — | — | — | — | — | — | — | — |
| (E) | UVI-6990 | — | — | 1 | 1 | — | — | — | — | — | 1 | — | 1 | — |
| | SP152 | 1 | 1 | — | — | — | — | — | — | — | — | — | — | — |
| Other component | Seloxide 2021 | — | — | — | — | — | — | — | — | — | — | — | 20 | 29 |
| | Seloxide 2081 | — | — | — | — | — | — | — | — | — | — | — | — | 20 |
| | Epolight 4000 | — | — | — | — | — | — | — | — | — | — | — | — | 21 |
| | Sunnix SP-250 | — | — | — | — | — | — | — | — | — | — | — | — | 14 |
| | UVI-6974 | — | — | — | — | — | — | — | — | — | — | 1 | — | 1 |
| | 1,9-nonanediol | — | — | — | — | 5 | 5 | 5 | 5 | — | — | — | — | — |
| | diacrylate | | | | | | | | | | | | | |
| | acryloylmorpholine | — | — | — | — | 16 | 16 | 16 | 16 | — | — | — | — | — |
| | urethane acrylate | — | — | — | — | — | — | — | 10 | — | — | — | — | — |

| | | | | | | | | | | | | | |
|---|---|---|---|---|---|---|---|---|---|---|---|---|---|
| Properties of cured product | | | | | | | | | | | | | |
| Refractive index | 1.56 | 1.57 | 1.58 | 1.57 | 1.57 | 1.57 | 1.57 | 1.57 | 1.57 | 1.57 | 1.57 | 1.57 | 1.54 |
| Transparency | good | good | good | good | good | good | good | good | good | good | good | good | good |
| Heat resistance | | | | | | | | | | | | | |
| After UV irradiation | good | good | good | good | good | good | good | good | good | bad | good | bad | bad |
| After heat treatment | good | good | good | good | good | good | good | good | good | bad | good | bad | bad |
| Warping | | | | | | | | | | | | | |
| After production (incl. processing step) | good | good | good | good | very | good | good | good | bad | good | bad | good | good |
| | | | | | good | | | | | | | | |
| Immediately after 85° C. × 30 min. | good | good | good | good | very | good | good | good | bad | good | bad | good | good |
| | | | | | good | | | | | | | | |

Neopol V779 (manufactured by Japan U-PICA Co., Ltd.): tetrabrominated bisphenol A epoxy diacrylate
Neopole V779MA (manufactured by Japan U-PiCA Co., Ltd.): tetrabromobisphenol A epoxy methacrylate
Aronix M110 (manufactured by Toagosei Co., Ltd.): paracumylphenoxy ethylene glycol acrylate
Epikote 5050 (manufactured by Japan Epoxy Resins Co., Ltd.): tetrabrominated bisphenol A diglycidyl ether
Light Ester PO (manufactured by Kyoeisha Chemical Co., Ltd.): phenoxyethyl methacrylate
New Frontier PHE (manufactured by Daiichi Kogyo Seiyaku Co., Ltd.): phenoxyethyl acrylate
New Frontier BR31 (manufactured by Daiichi Kogyo Seiyaku Co., Ltd.): tribromophenoxyethyl acrylate
Lipoxi VR-77 (manufactured by Showa Highpolymer Co., Ltd.): bisphenol A epoxy acrylate
Aronix M315 (manufactured by Toagosei Co., Ltd.): tris(acryloylethyl)isocyanurate
DPHA (manufactured by Nippon Kayaku Co., Ltd.): dipentaerythritol hexacrylate
Viscoat 295 (manufactured by Osaka Organic Chemical Industry Co., Ltd.): trimethylolpropane triacrylate
PA36-PEP (manufactured by Yokkaichi Gosei Co., Ltd.): sorbitol polyglycidyl ether
Denacol EX-411 (manufactured by Nagase ChemteX Corp.): pentaerythritol polyglycidyl ether
Epolead GT401 (manufactured by Daicel Chemical Industries, Ltd.): epoxidated butanetetracarboxylic acid tetrakis-(3-cyclohexenylmethyl) modified ε-caprolactone
Irgacure 184 (manufactured by Ciba Specialty Chemicals Co., Ltd.): 1-hydroxycyclohexyl phenyl ketone
Irgacure 651 (manufactured by Ciba Specialty Chemicals Co., Ltd.): 2,2-dimethoxy-1,2-diphenylethan-1-one
UVI-6990 (manufactured by Union Carbide): triallylsulfonium hexafluorophosphate mixture
SP152 (manufactured by Asahi Denka Kogyo K.K.): triallylsulfonium hexafluorophosphate mixture
Seloxide 2021 (manufactured by Daicel Chemical Industries, Ltd.): 3,4-epoxycyclohexylmethyl-3′,4′-epoxycyclohexanecarboxylate
Seloxide 2081 (manufactured by Daicel Chemical Industries, Ltd.): ε-caprolactone modified 3,4-epoxycyclohexenylmethyl-3′,4′-epoxycyclohexenecarboxylate
Epolight 4000 (manufactured by Kyoeisha Chemical Co., Ltd.): hydrogenated bisphenol A diglycidyl ether
Sunnix SP-250 (manufactured by Sanyo Chemical Industries, Ltd.): propione oxide addition glycerol
UVI-6974 (manufactured by Union Carbide): triallylsulfonium hexafluoroantimonate mixture

As is clear from Table 1, examples 1-4, a cured product of the composition of the present invention containing the compounds (A), (B), (C), (D), and (E) excels in heat resistance, shows a small amount of warping and deformation, and has a refractive index as high as 1.55 or more. As is clear from examples 5-8, the cured product of the composition of the present invention containing the compounds (A), (B), and (C) excelled in heat resistance, showed a small amount of warping and deformation, and had a refractive index as high as 1.55 or more. Therefore, the cured product is particularly useful as an optical part.

Therefore, the cured product is particularly useful as an optical component.

### EFFECT OF THE INVENTION

A cured product of the photocurable resin composition of the present invention excels in heat resistance and shows a small amount of deformation while maintaining a high refractive index. Therefore, the cured product is particularly useful as an optical component such as a prism lens sheet.

1. A photocurable resin composition comprising:
(A) (A1) a (meth)acrylate having a structure shown by the following formula (1) or (2), or (A2) an epoxy compound having a structure shown by the formula (1) or (2);
(B) a (meth)acrylate having three or more functional groups other than (A1);
(C) a radical photoinitiator; and
(E) a cationic photoinitiator 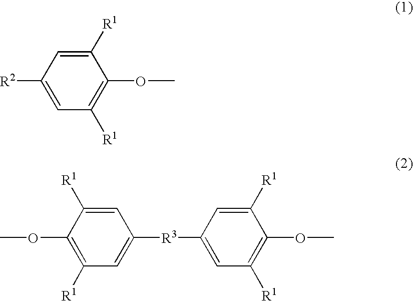
wherein R¹ represents a hydrogen atom or a halogen atom, excluding a fluorine atom, R² represents a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—,

2. The photocurable resin composition according to claim 1, wherein also a component (D) is present, wherein D is a compound having three or more cyclic ether linkages in the molecule other than (A2).

3. The photocurable resin composition according to claim 1, wherein the component (D) is an alicyclic epoxy compound.

4. The photocurable resin composition according to claim 1, wherein component (E) is a cationic photoinitiator containing a phosphorus atom.

5. A photocurable composition comprising at least two types of (meth)acrylates having specific structures (as shown in FIGS. 1 and 2) and a radical photoinitiator, wherein 5-50 wt % of the total acrylic components in the composition is a methacrylate component.

6. The photocurable resin composition according to claim 1, wherein component (A) is represented by 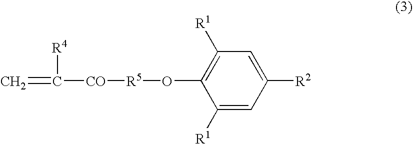
wherein R⁴ represents a hydrogen atom or a methyl group, R⁵ represents —C(OCH₂CH₂)ₖ—, —(OCH₂CH(CH₃))ₗ—, or —OCH₂CH(OH)CH₂—, k and l are individually an integer from 0 to 10, and R¹ represents a hydrogen atom or a halogen atom, excluding a fluorine atom and R² represents a hydrogen atom, a halogen atom excluding a fluorine atom, Ph-C(CH₃)₂—, Ph-, or an alkyl group having 1-20 carbon atoms.

7. The photocurable resin composition according to claim 1, wherein compound A is represented by 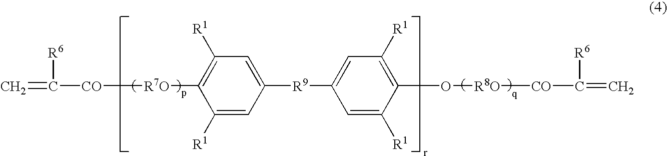
wherein R⁶ represents a hydrogen atom or a methyl group, R⁷ and R⁸ represent —CH₂CH₂—, —CH₂CH(CH₃)—, or —CH₂CH(OH)CH₂—, R⁹ represents —CH₂—, —S—, or —C(CH₃)₂)—, p, q, and r are individually an integer from 0 to 10, and R¹ represents a hydrogen atom or a halogen atom, excluding a fluorine atom.

8. The photocurable resin composition according to claim 1, wherein component (A) is selected from the group consisting of phenoxyethyl(meth)acrylate, phenoxyethoxyethyl(meth)acrylate, (meth)acrylate of p-cumylphenol reacted with ethylene oxide and 2,4,6-tribromophenoxyethyl(meth)acrylate

9. The photocurable resin composition according to claim 1, wherein component (A) is selected from the group consisting of ethylene oxide addition(tetrabromo)bisphenol A (meth)acrylate, (tetrabromo)bisphenol A diglycidyl ether epoxy(meth)acrylate obtained by epoxy ring-opening reaction of (tetrabromo)bisphenol A diglycidyl ether and (meth)acrylic acid.

10. The photocurable resin composition according to claim 1, wherein a cured product of the composition has a refractive index of 1.55 or more at 25° C.

11. The photocurable resin composition according to claim 1, wherein the softening point of a cured product of the composition is 40° C. or more.

12. An optical component obtainable by curing the photocurable resin composition according to claim 1.
